(19) United States
(12) Patent Application Publication
(10) Pub. No.: US 2005/0205121 A1
(43) Pub. Date: Sep. 22, 2005

(54) Modified bottom protection and shock absorption means for walking poles

(75) Inventor: Bo Lindgren, Boden (SE)

Correspondence Address: DICKSTEIN SHAPIRO MORIN & OSHINSKY LLP, 2101 L Street, NW, Washington, DC, 20037, US

(73) Assignee: Nordic Ski i Boden AB

(21) Appl. No.: 10/990,536

(22) Filed: Nov. 18, 2004

(30) Foreign Application Priority Data
Mar. 19, 2004 (WO) PCT/SE04/00416

(51) Int. Cl. A63B 71/00; A61H 3/02; A45B 9/04

(52) U.S. Cl. 135/78

(57) ABSTRACT

A bottom protection means (6) in the form of a bottom foot (5), and arranged for engaging a bottom part (2) of an ordinary walking pole (1) or a cane ending in a bottom pin or spur (4) of a preferably hard and wear resistant material, and in which said bottom protection means (6) is arranged for being locked in any optional position on said bottom part (2) of the walking pole (1), and in which said bottom protection means (6) is designed so that it can be moved freely up and down along the walking pole (1) and can thereafter be locked in any optional position thereon.

The present invention generally relates to a modified bottom protection and shock absorption means for walking poles, or sticks, of the type which are nowadays commonly used by persons of any age who exercise or otherwise walk on roads, streets, in the nature, on grounds covered by sand, gravel, asphalt, concrete, or on rock or stone or on snow or ice.

Walking poles of said type having a bottom protection means are known for instance from U.S. Pat. No. 2,376,282, FR patent 1.002.013 and WO publication 03/005852. The bottom protection means is generally made of rubber or a similar material having a high friction coefficient for preventing skidding of the pole on any walking base. The bottom protection and shock absorption means is generally formed for allowing the user to walk on smooth bases providing a good friction for the bottom of the pole, like on a floor, on streets, on rocks, on asphalt or concrete etc. For making the walking pole useful for walking on gravel, sand, snow, ice and other relatively soft substrates it is generally formed with a pin or a spur which can be expelled through the bottom of the protection means for use of the walking pole on such rather soft base material with part of the pin or spur partly penetrating into the walking base, and which pin or spur can be retracted into the bottom protection means when the pole is used for walking on other types of substrates like on a floor, on streets, on rocks, on asphalt etc.

In the apparatus of U.S. Pat. No. 2,376,282 and FR 1.002.013 there is provided a pin or spur which can be set into one of a couple of desired position, namely an expelled position for use at walking of a soft base, and a retracted position for use at walking on a solid base providing a good friction action. It may happen that the locking means for the bottom pin or spur accidentally switches from expelled position to retracted position, and this may cause accidents in case the bottom protection means slides on the base. During walking the entire pole is rotated from a generally vertical position to a position angled up to 45-60° against the walking surface, and this may cause the bottom protection means to get into contact with the walking surface with an edge thereof, whereby the pin or spur may become bent up from the substrate thereby becoming released from the walking surface, whereby there is likewise a risk that the walking pole slides along the walking surface.

It is therefore important that the bottom pin or spur can be expelled so far out from the bottom surface of the bottom protection and shock absorption means that there is no risk that the bottom protection means of the walking pole runs the risk of sliding along the walking surface. The walking pole according to WO 03/005852 therefore is formed with outer threads along the lower part of the pole, and the bottom protection means is formed with inner threads, so that said bottom protection means of said known type of walking pole may be screwed into any desired position on the threaded part of the walking pole with the pin or spur expelled a desired distance out of the bottom of the bottom protection means.

It is, however time consuming and troublesome to move the bottom protection means into the desired position on the walking pole by screwing same into said position by hand, and the hand by means of which the bottom protection means is screwed into position may slide on said bottom means, in particular since the hand and/or said bottom means may be wet or covered with snow or ice. It may also happen that sand and dirt enters the threads of the pole and the bottom protection means thereby making it hard to screw adjust the bottom protection means. The bottom protection means also may accidentally become screwed onto the threads of the walking pole. It also may happen that the inner threads of the bottom protection means become worn or even disappear, in which case said bottom protection means can not be safely locked in optional position of the lower part of the pole.

Therefore there has been a need for bottom protection means for a walking pole, or stick of the above mentioned type, which bottom protection and shock absorption means can be set into any optional position on the lower part of the walking pole, and in which said bottom protection and shock absorption means can be adjusted into any desired position on the walking pole quickly and without substantial efforts, in which the bottom protection means preferably can be moved freely into any position on the threaded, or non-threaded, lower part of the walking pole and can quickly, easily and without exerting any substantial effort be safely locked in any desired position on the walking pole.

According to the invention there is provided a bottom protection and shock absorption means, preferably for a walking pole formed as an ordinary walking pole having a threaded bottom, or non-threaded bottom part ending in a bottom pin or spur of a hard and wear resistant material, and which bottom protection and shock absorption means is formed for being locked in any optional position on the walking pole or any other type of cane or pole as well as in any optional height position and rotated position on said threaded, or non-threaded bottom part of the walking pole or cane, and which walking pole or cane is mainly characterized in that said bottom protection means is designed so that it can very quickly and easily be moved freely up or down along the (threaded portion) lower part of the walking pole and can be safely locked in any optional position thereon.

Further characteristics and advantages of the invention will be evident from the following detailed specification in which reference is made to the accompanying drawings, in which:

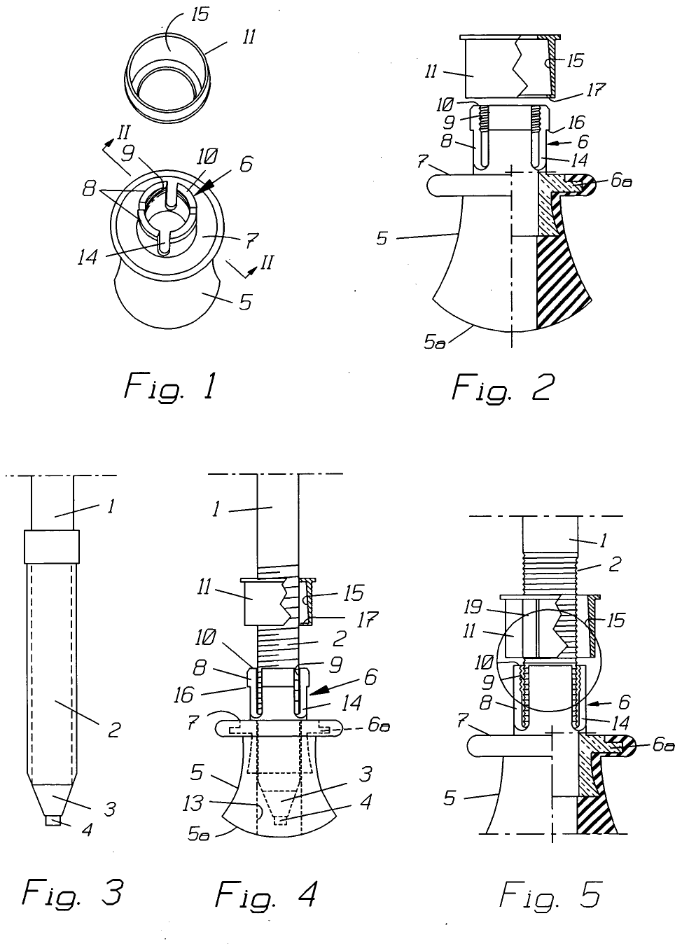

FIG. 1 is an exploded perspective view of a bottom protection and shock absorpotion means according to the invention, showing the different parts thereof separated.

FIG. 2 is a side view of the bottom protection means, seen along line II-II of FIG. 1, partly in a cross section view.

FIG. 3 is a side view of the lower part of a walking pole or a cane for which the bottom protection means is useful.

FIG. 4 is a side view of an embodiment of a bottom protection means according to the invention, partly in a cross section view, and in a position for locking the two parts in an optional mutual position.

FIG. 5 is a partly opened side view of a combination of an alternative embodiment of a bottom protection means and a walking pole or cane as shown in FIG. 3.

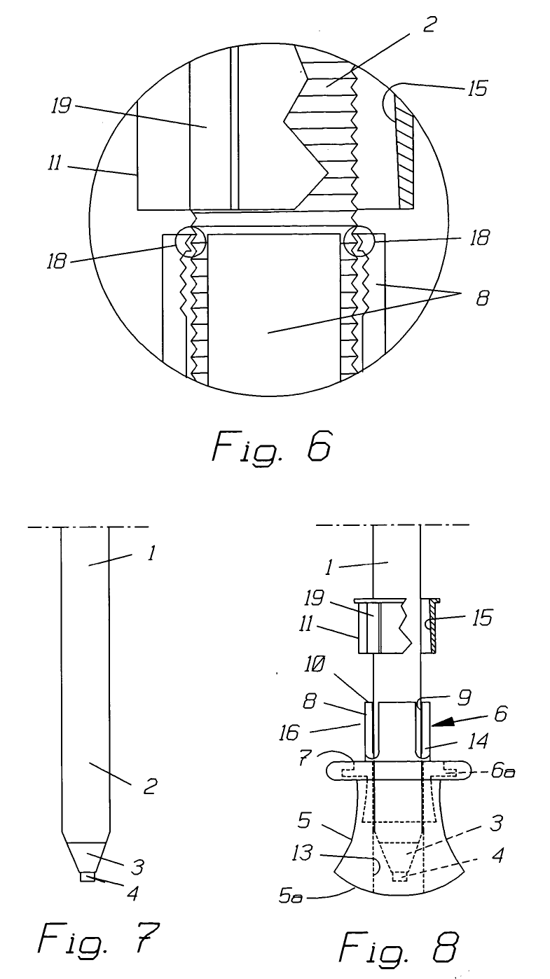

FIG. 6 is an enlarged view of the encircled part of FIG. 5 showing a slightly modified part of the bottom protection means.

FIGS. 7 and 8 show a modified embodiment of a walking pole or cane in combination with a modified bottom protection means, similar to what is shown in FIGS. 3 and 4.

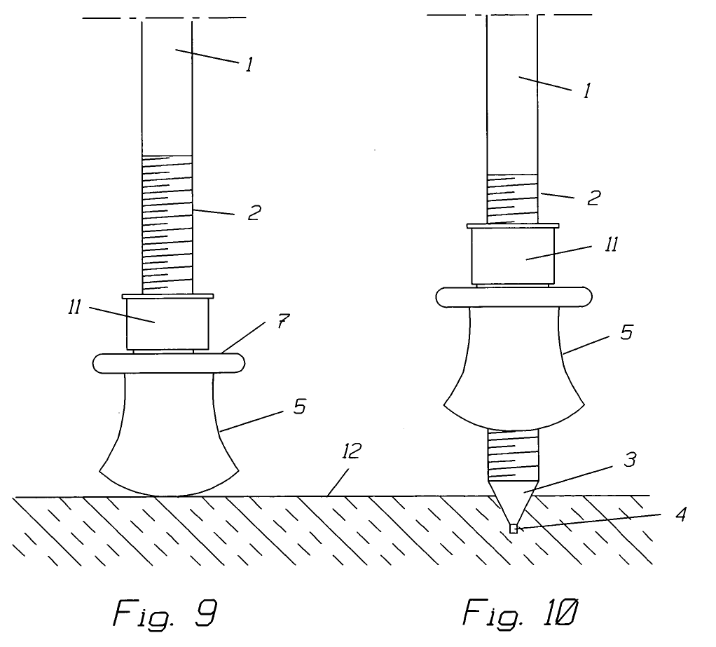

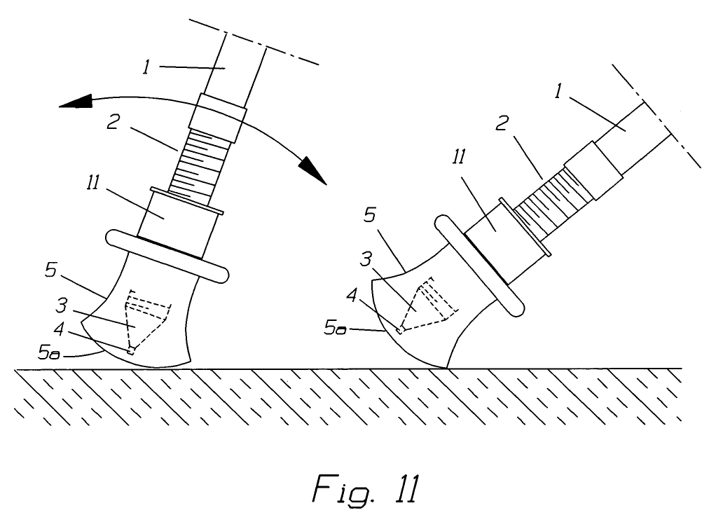

FIG. 9 is a side view of the walking pole with the bottom protection means according to the invention set for engagement with a smooth, hard walking surface like a floor, a rock, asphalt etc.

FIG. 10 is a like side view of the walking pole arranged for engagement with a soft walking surface like sand, earth, gravel, snow or ice.

FIG. 11 is an explanatory view showing the walking pole at two successive stages of a late position of the walking sequence.

The bottom protection means according to the invention, with the walking pole as shown in FIGS. 3 and 4 comprises a rather ordinary pole 1 which, at the bottom thereof, is formed with a threaded part 2 ending in a conical part 3 having, at the tip, a pin or spur 4 of a hard and wear resistant material, preferably of hard metal.

The bottom protection means, or foot, with the locking means, shown in FIGS. 1 and 2 comprises
(a) a bottom protection and shock absorption means 5 of a rubber or a rubber like elastic material having
(b) a locking means 6 in the form of an upwards from the top end, or flange 7, of the bottom protection means extending locking means formed as
(c) several resilient wings 8, in the illustrated case four wings, which are, in the embodiment shown in FIGS. 1 and 2, formed with inner threads 9, in the illustrated case e.g. 4-6 threads, at least over a slight distance from the top 10 of said wings 8, and
(d) a locking cone 11 which when pressed down over the locking means 6 forces the locking wings 8 into engagement with the outer surface, for instance the threads of the walking pole 1,
(e) and in which the locking means 6 is made of a relatively hard and resilient material like an amide plastic (Nylon®) and is secured by being cast vulcanized, at 6a, in the rubber or rubber like bottom protection means 5, as shown in FIGS. 2 and 5.

The bottom protection and shock absorption means is formed as a bottom foot 5 of a material providing a good friction engagement with a smooth, hard walking surface, like a floor, an asphalt or concrete street or pavement 12 (see FIGS. 9-11). The material of the bottom foot 5 may be rubber, synthetic rubber or a similar material. The bottom foot 5 is formed with an axial through bore 13 for the lower part 2 of the walking pole 1 and has a bottom surface which is preferably a segment of a sphere 5a giving a good ground support for the walking pole over a wide angle of rotation of the pole, for instance an angle of 45-60° in relation to the ground (see FIG. 11).

The locking means 6 preferably is of a hard, resilient material, for instance self-lubricating material, like a polyamide plastic material (Nylon®), which locking means is secured inside a bore 13 of the rubber bottom protection means 5, preferably by being vulcanized thereto, as shown in FIGS. 2 and 5. The locking means 6 extends with the wings 8 thereof a substantial distance up over the top surface or flange 7 of the bottom protection means, i.e. the foot 5. Said projecting parts are formed as several, in the illustrated case four, separate wings 8 which are integral with the part of the locking means 6 which is secured inside the rubber foot 5. The wings 8 define U-shaped recesses 14 intermediate adjacent wings. The bottom of each recess 14 ends flush with, or slightly above the top surface 7 of the rubber foot 5. At the uppermost part said wings 8 are, in the embodiment shown in FIGS. 1-6 and 9-11, formed with a few inner threads 9, for instance 4-6 threads 9 adjacent the upper end of the wings 8, which threads 9 match the outer threads 2 of the walking pole. The wings 8 with the threads 9 are formed with a diameter which is at least slightly greater than that of the threaded part 2 of the walking pole 1, so that the bottom foot 5 with the locking means 6 can slide, or be moved, freely along the threaded part 2 of the walking pole 1 and can be engaged to the pole threads 2 and can be locked thereto by forcing the locking cone 11 down over the wings 8.

The locking cone 11 is formed as a sleeve having an inner cone surface 15 matching the outer surfaces and the periphery of the wings 8, and it is of such size and shape that said inner cone surface 15 clamp the upper parts of the wings 8 with the inner threads 9 thereof into engagement with the outer threads 2 of the walking pole when pressed down over said wing part. Thereby the entire bottom protection means 5 becomes secured in any desired position on the walking pole. Releasing said locking cone 11 by pulling same up from the wings 8 makes the bottom protection means 5, 6 free from the walking pole so that it can be readjusted to any other position on the threaded part 2 of the walking pole 1.

The bottom foot 5 with the wings 8 normally engages the threads 2 of the walking pole 1 so strongly that the bottom foot 5 can not unintentionally rotate on the walking pole, but it may be adjusted slightly along the walking pole by being screwed thereon by hand force.

The wings 8 may be formed with an outer rim 16 adjacent the upper end thereof, and the locking cone 11 may be formed with a corresponding inner bottom flange 17 of such diameter that it engages under the wing rim 16 so that said locking cone 11 is always present together with the bottom foot 5, even if the entire bottom protection part 5, 11 is released from the walking pole 1, 2.

Alternatively, and as shown in FIG. 8, the wings 8 have no outer rims, and the locking cone 11 has no inner flange. The threads 2 of the pole 1 may be formed in a sleeve which is glued onto the bottom part of the pole, as shown in FIGS. 3 and 11. It is alternatively also possible to form the threads directly on the metal pole 1 as shown in FIGS. 4-10. As a still alternative the threads may be provided on a sleeve of fiber glass, or on a composite material, which sleeve is likewise glued onto the pole.

FIG. 9 illustrates the situation at walking on a smooth, hard surface 12, like a floor, a street, a pavement, on asphalt or concrete etc., whereby the bottom protection means 5, 11 is locked in a low position on the walking pole 1, 2 and the pin or spur 4 is located inside the rubber foot 5.

FIG. 10 shows the situation in which the walking pole 1, 2 is used for walking on a soft surface 12, like on sand, gravel, earth, snow, ice etc., whereby the lower part of the pole with the conical part 3 and the pin or spur 4 have been moved down to a position expelled out of the rubber foot 5 and the pin or spur 4 can be pressed down into the ground, or in the snow or ice, in case it is important that the pin or spur 4 provides an engagement with the ground or ice surface.

In the latter case it may be of importance that the foot 5 is secured at a rather high position on the threaded part 2, or a non-threaded lower part of the walking pole 1, so that the foot does not prize the pin or spur 4 up from the sand or ice surface at a late stage of a walking cycle, whereby the walking pole may take a an angular position of 45-60° in relation to the ground surface 12 (see right picture of FIG. 11).

In order to prevent the bottom protection means from unintentionally rotating on the pole the uppermost one or two threads of inner threads 9 of the wings 8 may be extended inwards, as shown by 18 in FIG. 6, whereby said inner thread parts 18 provide a resilient locking of the bottom protection means 5, still with the possibility of rotating, if desired, the bottom protection means 5, by hand, on the walking pole 1, degree by degree, so that the bottom sphere 5a becomes evenly worn.

Another way of providing a resilient locking of the wings 8 on the pole 1 is to make said wings 8 of a material having a rather high coefficient of friction, whereby the bottom protection means 5 is prevented from unintentionally rotating on the pole 1.

In order to facilitate handling and the removal of the locking cone of the outer periphery of said some or all wings 8 may be formed with outer vertical ribs 19 (see FIG. 5) forming grips for handling of said locking cone 11.

### REFERENCE NUMERAL

1 walking pole
2 (outer) threaded part (of 1)
3 conical part
4 pin, spur
5 bottom protection means, foot
5a bottom sphere
6 locking means (sleeve)
6a sphere
7 top surface
8 wings
9 inner threads
10 top (of 8)
11 locking cone
12 base surface
13 bore (of 6)
14 U-shaped recess
15 inner cone surface (of 11)
16 rim (of 8)
17 inner flange (of 11)
18 extended thread parts
19 outer rib

1. Bottom protection and shock absorption means (5), for instance for use on walking poles or canes (1, 2), arranged for being locked in any optional height position as well as a rotated position on the bottom part (2) of a walking pole (1) or cane, characterized in that said bottom protection means (5, 11) is designed so that it can be moved freely up and down along the lower part (2) of such walking pole (1) and can be locked in any optional position thereon.

2. Bottom protection and shock absorption means (5) according to claim 1, characterized in that the bottom protection and shock absorption means comprises a bottom foot (5) of rubber or a rubber like material and a locking means (6), which projects above the top surface (7) of the rubber foot (5).

3. Bottom protection and shock absorption means (5) according to claim 2, characterized in that the locking means (6) is at least partly resilient and is formed with an inner diameter which is slightly greater than that of the bottom part (2) of the walking pole (1).

4. Bottom protection and shock absorption means (5) according to claim 3, characterized in that said resilient locking means (6) is formed as several, for instance four, resilient, upwardly projecting wings (8) extending above the top surface (7) of the rubber foot (5).

5. Bottom protection and shock absorption means (5) according to claim 4, characterized in that the several locking wings (8) provide U-shaped recesses (14) between adjacent wings (8), which U-recesses (14) extend down to a position adjacent or slightly above the top surface (7) of the rubber foot (5).

6. Bottom protection and shock absorption means (5) according to any of claim 3, characterized in that the locking means comprises a locking cone (11) adapted to engage the outer periphery of the locking wings (8) of the locking means (6) by being pressed down thereover, so as to press said locking wings (8) radially inwards into engagement with the bottom part (2) of the walking pole (1).

7. Bottom protection and shock absorption means (5) according to claim 6, characterized in that the locking cone (11) is formed with an inner, upwards converging surface (15) matching the outer periphery of the wings (8) so that said locking cone (11) presses the wings (8) so hard into engagement with the bottom part (2) of the walking pole (1) when pressed down over said wings (8) that said bottom protection means (5) can not be rotated un-intentionally but can be screwed by hand up or down on the walking pole (1).

8. Bottom protection and shock absorption means (5) according to claim 2, characterized in that the locking means (6) is secured by being mould connected or vulcanized inside the bottom foot (5), and in that said locking means (6) including the projecting wings (8) are made of a hard and resilient, preferably self-lubricating material, like a polyamide plastic material (Nylon®).

9. Bottom protection and shock absorption means (5) according to any of claim 4, characterized in that it is formed and designed for being used in combination with an ordinary walking pole (1) having an exteriorly threaded bottom part (2) ending in a bottom pin or spur (4) of a preferably hard and wear resistant material, and in that the locking wings (8) are formed with few inner threads (9), for instance 3-6 threads, adjacent the top ends thereof, which threads (9) match the threads of the exteriorly threaded part (2) of the walking pole (1).

10. Bottom protection and shock absorption means (5) according to claim 9, characterized in that the wings (8) are formed with an outer rim (16) adjacent the upper part thereof, and in that the locking cone (11) is formed with an inner flange (17) at a lower part of said locking cone (11), which inner flange (17) engages underneath said outer wing rim (16) in the releasing position of the locking means (6).
